(19) United States
(12) Patent Application Publication
(10) Pub. No.: US 2002/0186647 A1
(43) Pub. Date: Dec. 12, 2002

(54) Magnetic coupling power transmission apparatus for optical disk drive

(75) Inventors: Sun-Cha Her, KeeLung (TW); Shao-Hsiung Chang, Taipei (TW)

Correspondence Address: DISCOVISION ASSOCIATES, INTELLECTUAL PROPERTY DEVELOPMENT, 2355 MAIN STREET, SUITE 200, IRVINE, CA, 92614, US

(73) Assignee: DELTA ELETRONICS INC.

(21) Appl. No.: 09/874,254

(22) Filed: Jun. 6, 2001

(51) Int. Cl. G11B 23/00; H02P 15/00; G11B 25/00; H02K 49/00

(52) U.S. Cl. 369/266; 310/103

(57) ABSTRACT

A magnetic coupling power transmission apparatus for optical disk drive includes a motor with a magnetic conductive member attached to its spindle and a shaft for driving the optical disk drive having a magnetic inductive member mounted thereon. The magnetic conductive member has a plurality even number of north and south pole magnets alternatively located thereon. The magnetic inductive member has a plurality even number of south and north pole magnets located thereon to mate against the magnetic conductive member. The magnetic conductive member is spaced from the magnetic inductive member to produce magnetic attraction between the north and south poles between the two members. Motor rotation power may be transmitted through this magnetic coupling to the optical disk smoothly and with less noise than conventional gear train engagement.

### FIELD OF THE INVENTION

This invention relates to magnetic coupling power transmission apparatus for optical disk drive that uses magnetic inductive force to transmit power for driving optical disk drive.

### BACKGROUND OF THE INVENTION

Optical disk drive is a widely used computer data storage device particularly in computer multimedia applications because of its compact size and huge data storage capability. Conventional optical disk uses mechanical means for power transmission. FIGS. 1A, 1B and 1C show a typical conventional power transmission scheme used in optical disk drive. It has a motor 1 attached a driving gear 10 on a spindle 3. The transmission means has a driven gear 20 engageable with the driving gear 10 and a shaft 20 to output power for driving the optical disk drive. This gear to gear power transmission has mechanical contact and impact and friction. The positional alignment should be very precise. Nevertheless, there is still tolerance between the gears. Hence after operation for a period of time, friction and impact between the gears tend to enlarge the tolerance and may result in greater impact and vibration and produce a lot of noise. And it may even cause optical disk drive malfunction and decrease durability.

### SUMMARY OF THE INVENTION

It is therefore an object of this invention to provide a magnetic coupling power transmission apparatus that has no direct mechanical contact and may result in more smooth power transmission with no friction, less noise and enhanced optical disk drive durability.

The magnetic coupling power transmission apparatus according to this invention includes a motor controlled by an optical disk drive circuit and a magnetic conductive member mounted on the motor spindle. In the optical disk drive, there is a transmission shaft attached to a magnetic inductive member which may be coupled with the magnetic conductive member, through magnetic attraction force and be driven by the motor for transmission motor power to the optical disk drive. As there is no mechanical contact between the magnetic conductive and inductive member, there is no mechanical friction and impact between the two, power transmission may be done smoothly at much lower noise. Total durability may also be greatly enhanced. Various magnetic conductive and inductive forms may be used to achieve the result desired.

### BRIEF DESCRIPTION OF THE DRAWINGS

The invention, as well as its many advantages, may be further understood by the following detailed description and drawings in which:

FIGS. 1A, 1B and 1C are perspective views of conventional power transmissions apparatus.

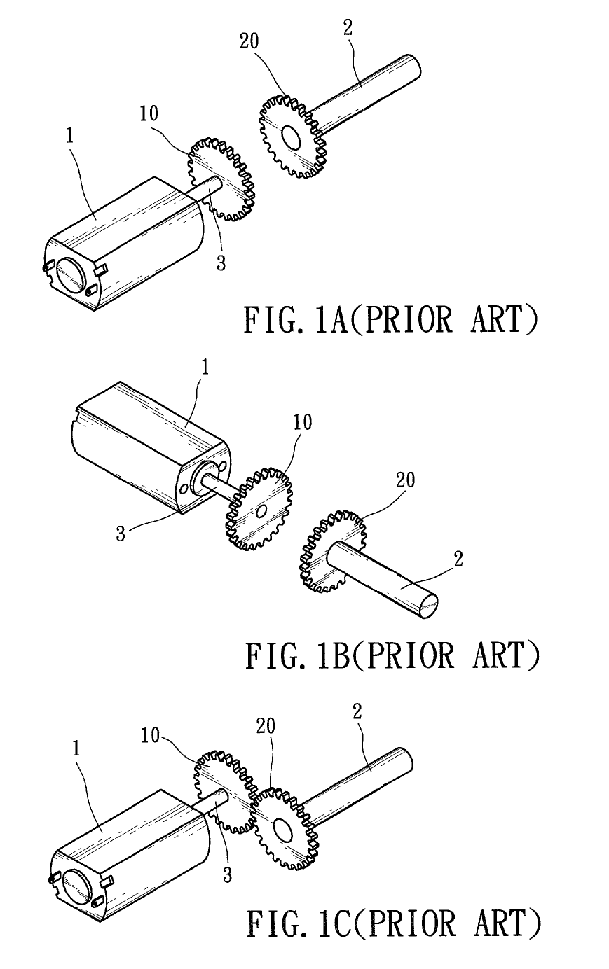

FIGS. 2A, 2B and 2C are perspective views of a first embodiment of this invention.

FIGS. 3A, 3B and 3C are perspective views of a second embodiment of this invention.

FIGS. 4A, 4B and 4C are perspective views of a third embodiment of this invention.

FIGS. 5A, 5B and 5C are perspective views of a fourth embodiment of this invention.

### DETAILED DESCRIPTION OF THE PREFERRED EMBODIMETN

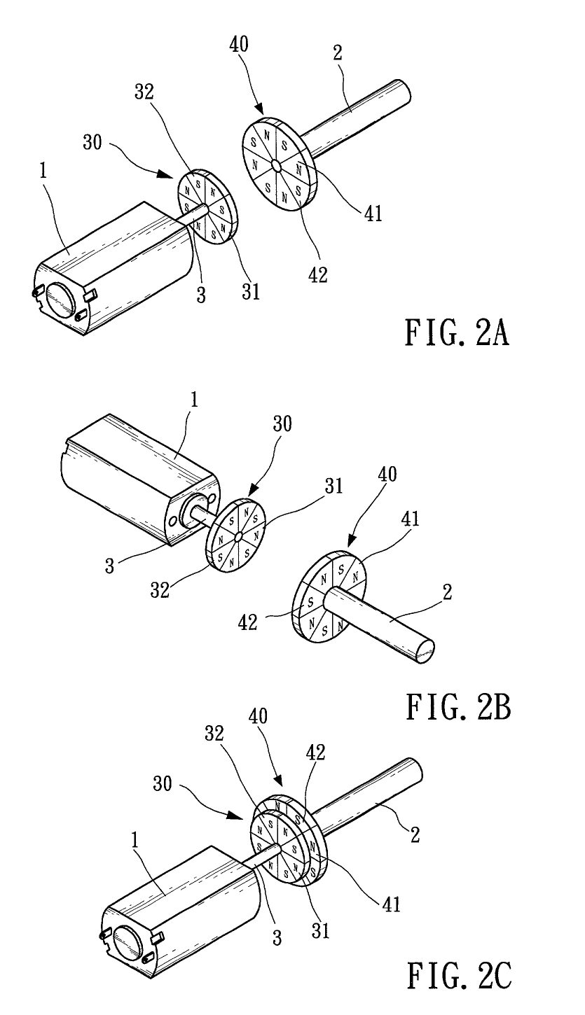

Referring to FIGS. 2A, 2B and 2C, the magnetic coupling power transmission apparatus of this invention includes a motor 1 attached with a magnetic conductive member 30 on a spindle 3. The magnetic conductive member 30 which may be formed in a disk shape has an even number of north magnetic poles 31 (N) alternatively located among equal number of south magnetic poles 32 (S). The optical disk drive (not shown in the figures) is driven by a shaft 2 which has a magnetic inductive member 40 mounted at one end thereof. The magnetic inductive member 40 may also be formed in a disk shape and has an even number of south pole 42 (S) and north pole 41 (N) alternatively formed therein to match respectively the north and south poles 31 and 32 (shown in FIG. 2C). The magnetic inductive member 40 and magnetic conductive member 30 couple with each other at an interval but without direct contact. Because of magnetic attraction force between the north pole and south pole (31 to 42, and 32 to 41), the motor 1 may transmit its rotation power to the optical disk drive through the spindle 3 to the shaft 2. The rotation will be controlled by means of the circuit in the optical disk drive.

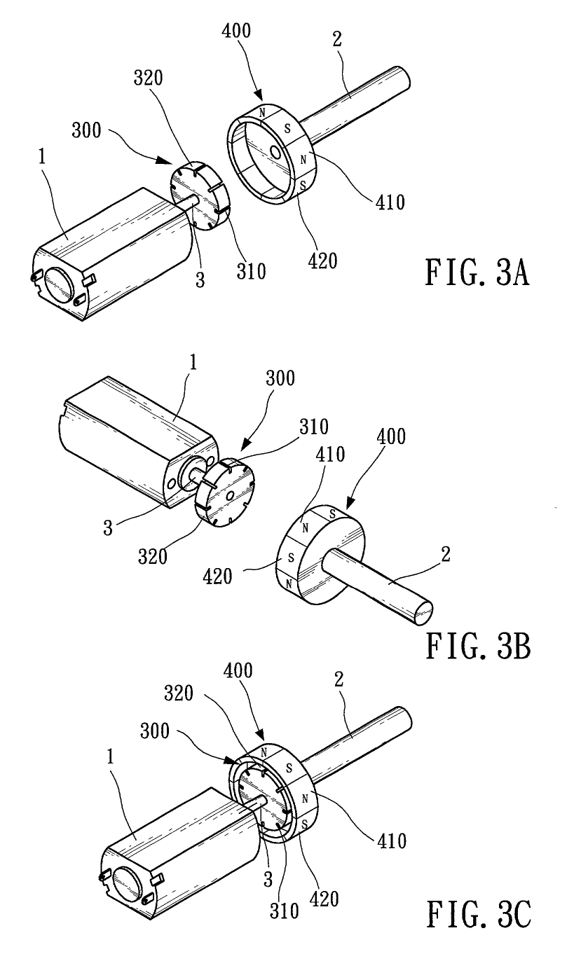

FIGS. 3A, 3B and 3C show a second embodiment of this invention. It is largely constructed like the one shown in FIG. 2. However the magnetic conductive member 300 is formed like a wheel with a plurality of notches 310 formed in the perimeter and a plurality of curved stubs 320 formed between the notches 310 alternatively. The magnetic inductive member 400 has a circular ring with even number of north poles 40 (N) alternatively sandwiched between the south poles 420 (S). The magnetic conductive member 300 is held in the magnetic inductive ring (shown in FIG. 3C) with an interval therebeween. Hence the magnetic attraction force between the magnetic conductive member 300 and magnetic inductive member 400 may transmit motor power from the spindle 3 to the shaft 2 for driving the optical disk drive (not shown in the figures).

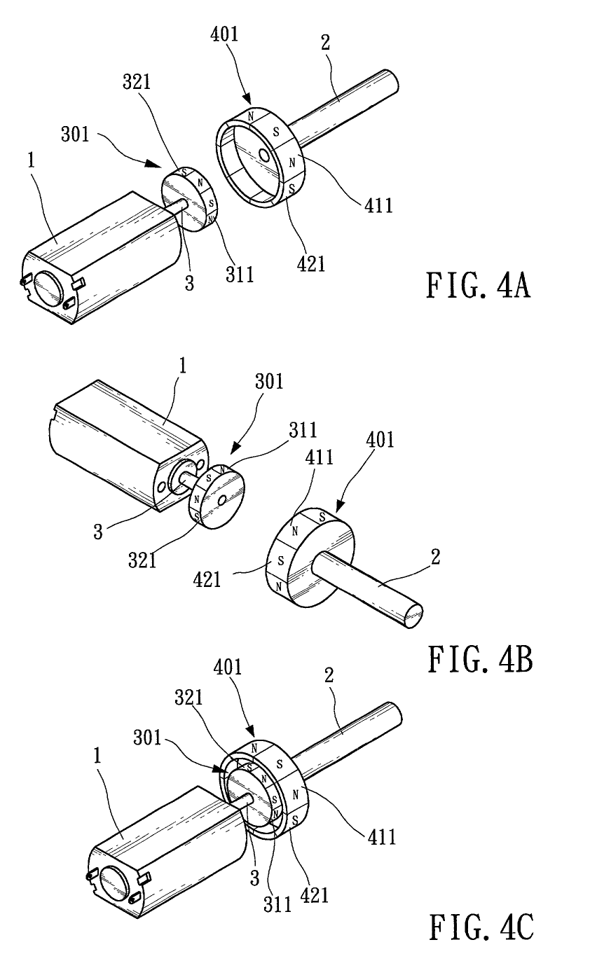

FIGS. 4A, 4B and 4C show a third embodiment of this invention. It is mostly constructed like the one shown in FIG. 3. However the magnetic conductive member 301 has a plurality of north poles 311 (N) alternatively sandwiched between the south poles 321 (S) at the perimeter to replace respectively the notches 310 and stubs 320. It can function equally will like the one shown in FIG. 3.

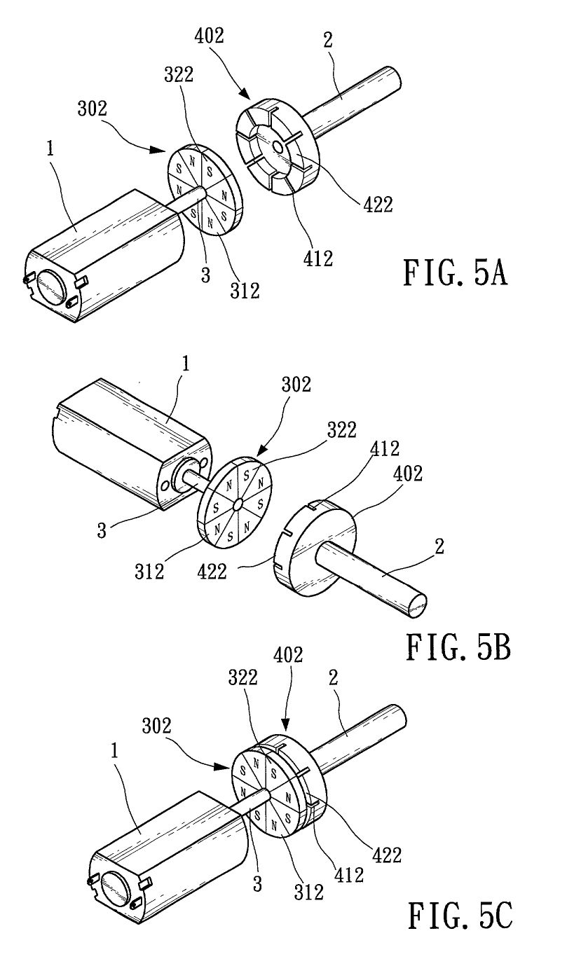

FIGS. 5A, 5B and 5C show a fourth embodiment of this invention. It is largely constructed like the one shown in FIG. 4. However the magnetic conductive member 302 has the north pole slices 312 and south pole slices 322 to form a complete disk member. The magnetic inductive member 402 has a ring which includes a plurality of notches 412 alternatively sandwiched by stubs 422 to match the north pole slices 312 and south pole slices 322. When in use, the magnetic conductive member 302 is held against the magnetic inductive member 402 with an interval therebetween. It can function equally well as the one shown in FIG. 4.

In summary, this invention uses magnetic attraction force between opposite magnetic poles to transmit motor rotation power for the optical disk drive. There is not direct mechanical contact between the driving member (such as the magnetic conductive member 30, 300, 301, or 302) and the driven member (such as the magnetic inductive member 40, 400, 401 or 402). Hence there is no friction or wearing between them. The operation noise is much lower. Durability may be greatly enhanced. Assembly and position of the components also become less critical or sensitive to physical alignment precision. Production and assembly time and cost thus may be reduced.

It may thus be seen that the objects of the present invention set forth herein, as well as those made apparent from the foregoing description, are efficiently attained. While the preferred embodiments of the invention have been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A magnetic coupling power transmission apparatus for optical disk drive, comprising:
a motor having a spindle which has one end and a magnetic conductive member mounted at the spindle end; and
a shaft engaged with the optical disk drive having a magnetic inductive member attached at another end and spaced from the magnetic conductive member for a selected distance to produce magnetic attraction force therebetweeen;
wherein the motor is activated to transmit rotation power to the optical disk drive through the spindle, magnetic conductive and inductive members and the shaft.

2. The magnetic coupling power transmission apparatus of claim 1, wherein the motor rotation is controlled by the optical disk drive.

3. The magnetic coupling power transmission apparatus of claim 1, wherein the magnetic conductive member is formed in a disk with a plurality even number of north poles alternatively sandwiched by even number of south poles.

4. The magnetic coupling power transmission apparatus of claim 1, wherein the magnetic inductive member is formed in a disk with a plurality even number of north poles alternatively sandwiched by even number of south poles.

5. The magnetic coupling power transmission apparatus of claim 1, 3 or 4 wherein the north poles and south poles in the magnetic conductive member mate respectively against the south and north poles of the magnetic inductive member.

6. A magnetic coupling power transmission apparatus using magnetic induction for power transmission to an optical disk drive which comprising:
a motor controlled by a circuit in the optical disk drive having a spindle;
a magnetic conductive member mounted at one end of the spindle;
a shaft engageable with the optical disk drive; and
a magnetic inductive member attached to the shaft and spaced form the magnetic conductive member to produce magnetic attraction force therebetween for transmitting motor rotation power to the optical disk drive.

7. The magnetic coupling power transmission apparatus of claim 6, wherein the magnetic conductive member is shaped like a wheel and includes a plurality even number of notches formed in a perimeter thereof and a stub formed between each pair of notches.

8. The magnetic coupling power transmission apparatus of claim 6, wherein the magnetic conductive number is shaped like a wheel and includes a plurality even number of north poles formed at wheel perimeter and a south pole formed between each pair of north poles.

9. The magnetic coupling power transmission apparatus of claim 6, wherein the magnetic inductive member has a circular ring which includes a plurality even number of north poles and a south pole formed between each pair of north poles to form a holding space in the ring.

10. The magnetic coupling power transmission apparatus of claim 9, wherein the magnetic conductive member is held in holding space to induce magnetic attraction force for transmitting motor rotation power to the optical disk drive.

11. The magnetic coupling power transmission apparatus of claim 10, wherein the magnetic conductive member has its south and north poles mating respectively against the south and north poles of the magnetic inductive member to induce magnetic attraction therebetween at an interval.

12. A magnetic coupling power transmission apparatus for optical disk drive, comprising
a motor located in the optical disk drive having a spindle attached to a magnetic conductive member; and
a shaft attached with a magnetic inductive member to have magnetic interaction with the magnetic conductive member for transmitting motor rotation power to the optical disk drive.

13. The magnetic coupling power transmission apparatus of claim 12, wherein the motor rotation is controlled by a control circuit in the optical disk drive.

14. The magnetic coupling power transmission apparatus of claim 12, wherein the magnetic conductive member is formed in a disk including a plurality even number of north poles and a plurality of south poles each being located between a pair of the north poles.

15. The magnetic coupling power transmission apparatus of claim 12, wherein the magnetic inductive member is formed in a disk shape having a plurality even number of notches and a stub formed between each pair of notches to produce magnetic interaction with a plurality even number of magnetic poles in the magnetic conductive member.

16. The magnetic coupling power transmission apparatus of claim 12, 14 or 15, wherein the magnetic conductive member has a plurality even number of north and south poles to mate against respectively south and north poles located in the magnetic inductive member.
